(19) United States
(12) Patent Application Publication
(10) Pub. No.: US 2026/0340994 A1
(43) Pub. Date: Oct. 29, 2026

(54) DYNAMIC MODEL SELECTION FOR DETECTION ACCROSS DIVERSE SITUATIONS

(71) Applicant: TurbineOne. Inc., San Francisco, CA (US)

(72) Inventors: Keith Joseph Goldberg, Winter Park, FL (US); Daniel Hebb, San Diego, CA (US); Sandeep Mittal, Garner, NC (US); Matthew Warren Amacker, Santa Clara, CA (US)

(21) Appl. No.: 19/192,104

(22) Filed: Apr. 28, 2025

(51) Int. Cl. G06V 10/77; G06V 10/44; G06V 10/70; G06V 20/50

(52) U.S. Cl. CPC G06V 10/7715; G06V 10/44; G06V 10/87; G06V 20/50

(57) ABSTRACT

A computing system may store a set of machine learned models trained to detect an object across a variety of different situations. The computing system may receive media captured by a sensor in an environment, the media representing the object the environment. The computing system may transform a portion of the media into a first feature vector which captures temporal and spatial features of the portion of the media. The computing system may map second feature vectors corresponding to machine learned models in the set of models to the first feature vector of the media. The computing system may select a machine learned model from the set of models based on the mapping of the second feature vectors to the first feature vector. The computing system may perform object detection by applying the portion of the media to the selected machine learned model.

### TECHNICAL FIELD

The present disclosure relates to machine learning, and, in particular, to the selection and utilization of specialized machine learning models for detecting and analyzing objects or events in diverse environments.

### BACKGROUND

Machine learning can enable automated object detection using object detection models trained on sample media, including images and videos. However, generalized detection models, while versatile, are inadequate in providing accurate responses when applied to specific or specialized detection tasks.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

Figure (FIG. 1 illustrates a block diagram of a system environment in which a computing system operates, in accordance with one embodiment.

FIG. 2 depicts a block diagram of the computing system of FIG. 1, in accordance with one embodiment.

FIG. 3A is a flowchart diagram illustrating how metadata feature vectors are generated, according to an embodiment.

FIG. 3B is a flowchart diagram illustrating how object detection models are selected and how output detections are generated, according to an embodiment.

FIG. 4. is a flowchart for a method for determining an object detection model and performing object detection, in accordance with one embodiment.

FIG. 5 is a block diagram illustrating components of an example machine able to read instructions from a machine-readable medium and execute them in a processor (or controller).

FIG. 6 is a flowchart that illustrates and example inference flow, according to one or more embodiments.

FIG. 7 is a flowchart for a method for performing ensemble object detection on media, in accordance with one or more embodiments.

### DETAILED DESCRIPTION

The Figures (FIGS.) and the following description relate to embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Some embodiments address the challenge of accurately detecting and classifying objects over various situations. Traditional generalized object detection models fall short in detecting objects in specific situations, leading to suboptimal detection performance. Furthermore, even if a person has several specialized models at their disposal, determining which model to use for a given sample of media may be difficult or time consuming. For example, each of the specialized models may be applied to the media and then the detection accuracy may be compared to determine the best model.

To address these limitations, a system includes a library of specialized models which are trained to detect objects in a variety of different situations (e.g., different lighting conditions). The system employs a feature extractor that transforms incoming media into high-dimensional feature vectors. These vectors may represent the media's semantic attributes (e.g., including the situation represented by the media), which allow for precise mapping to one or more suitable specialized models in the library. For instance, the system can differentiate between scenarios such as boats in a dock versus boats in open water or automobiles in a crowded intersection versus low-traffic intersection. This approach helps ensure high-fidelity detections which are tailored to the specific situation of the media, e.g., visual media, thereby improving overall detection accuracy and model selection efficiency for many different situations. Furthermore, the system may dynamically switch one or more models based on real-time analysis of the media, which further increases overall detection accuracy. For example, if the situation in a sample of media changes (e.g., the light conditions change), the system may switch from a current set of one or more models to a new set of one or more models which is better tailored to the new situation.

The system may also allow for more efficient resource utilization since fewer models may be active in memory at any given time.

Other aspects include components, devices, systems, improvements, methods, processes, applications, computer readable mediums, and other technologies related to any of the above.

### Example Use Cases

The following paragraphs provide example use cases of the system from the perspective of a user interacting with the system (e.g., via a graphical user interface (GUI) on their client device). In some use cases, a user has media that they desire to apply to an object detection model (e.g., data captured by one or more sensors). For example, the user is part of a security team monitoring boat traffic moving in and out of a harbor, and the media is video footage of the harbor captured by a security camera. In this example, the user may desire for one or more object detection models to detect boats in the video footage.

In a first example, the user may review the available objection detection models stored in the library and select one or more models to apply to their media. In this example, the system may provide feedback on the user's model selection. In another example, the user may describe their media or describe the type of model they want to apply to their media (e.g., via natural language input via their client device), for example, if the user is unsure which object detection model to use. Additionally, or alternatively, a description of the media or a desired model may be automatically generated by a trained model of the system (e.g., a natural language module). The system receives the description and determines which objection detection models to use. The system may then provide a model recommendation to the user (e.g., via a GUI) or apply the media to the determined one or more models. If a recommendation is provided, the user may be able to approve, modify, or deny the recommendation.

In addition to, or alternative to, the previous example, the user provides the media or a subset of the media to the system (e.g., if the user doesn't know what objects or situations are in their media). The system analyzes the received media and determines which set of one or more objection detection models to use. The system may then provide a model recommendation to the user (e.g., via a GUI) or apply the media to the determined set. A model recommendation may include example or sample detections performed by the set in the recommendation (e.g., based on the user's media or another sample of media). After the media is applied to a set of one or more object detection models (e.g., after the user approves the set), the system may provide the detection output to the user for review. The user may provide feedback (e.g., via a GUI) for the set or the detection output.

### Example System Environment

Aspects of the present disclosure relate to machine learning-driven object detection using specialized models to increase object detection accuracy.

FIG. 1 illustrates a block diagram of a system environment 100 in which a computing system 110 operates, in accordance with one embodiment. The system environment 100 includes a computing system 110, sensor(s) 120, client device(s) 130, and a network 140. The system environment 100 may have alternative configurations than shown in FIG. 1, including different, fewer, or additional components.

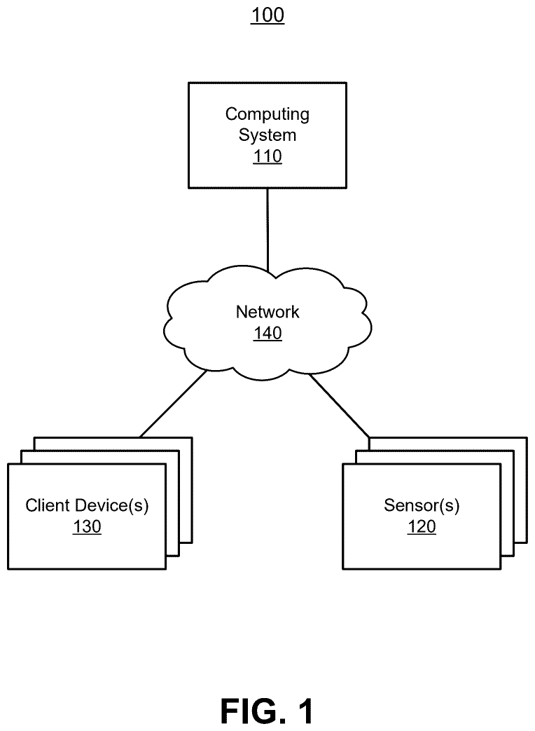

The computing system 110 implements machine learning-driven object detection. The computing system 110 may reside on a remote server communicatively coupled to the client device(s) 130. Although the computing system 110 is depicted as remote from the client device(s) 130, in alternative embodiments, the computing system 110 may reside on the client device(s) 130 and be executed from the client device(s) 130. The computing system 110 is described further with respect to the description of FIG. 2.

The sensor(s) 120 capture image data. For example, sensor 120 captures image data of an external environment (e.g., the ocean or a dock). The sensor(s) 200 can include an imaging camera, infrared camera, depth camera, or any suitable optical sensor for capturing image data. The sensor(s) 120 may be co-located with other components of the computing system 110 or located remotely (e.g., a camera located on a satellite that transmits the captured images to a ground-based remote server). The image data may include video or images. In some embodiments, the sensor(s) 120 may capture non-image data. For example, the sensor(s) 120 may include a microphone that captures audio. The computing system 110 may train a machine learning model to detect activity or objects from non-image data (e.g., a machine learning model trained to detect an object (e.g. boats) from noises caused by that object (e.g., the sound of boat engines)).

A client device, such as the client device(s) 130, may be a personal computer (PC), a tablet PC, a smartphone, or any suitable device capable of executing instructions that specify actions to be taken by that device. The client device(s) 130 may include one or more processors (e.g., one or more central processing units (CPUs), one or more graphics processing units (GPUs), one or more digital signal processors (DSPs), one or more application specific integrated circuits (ASICs), one or more radio-frequency integrated circuits (RFICs), or any combination of these), a memory, a user interface to receive user inputs or provide outputs to the user (e.g., a visual display interface including a touch enabled screen, a keyboard, microphone, speakers, etc.). The visual interface may include a software driver that enables displaying user interfaces on a screen (or display).

The network 140 may serve to communicatively couple the computing system 110, the sensor(s) 120, and the client device(s) 130. In some embodiments, the network 140 includes any combination of local area and/or wide area networks, using wired and/or wireless communication systems. The network 140 may use standard communications technologies and/or protocols. For example, the network 306 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 306 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 140 may be encrypted using any suitable technique or techniques.

### Example System Configuration

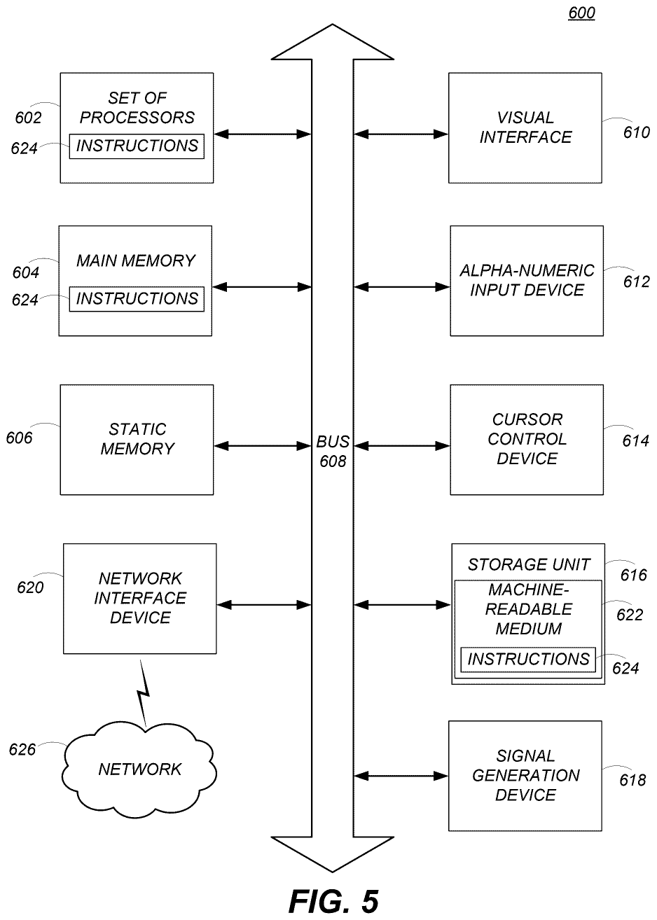

FIG. 2 depicts a block diagram of the computing system 110 of FIG. 1, in accordance with one embodiment. The computing system 110 includes sensor(s) 200, a detection engine 210, object detection model(s) 211, a training engine 220, a training database 230, a model diagnostic engine 240, a graphical user interface (GUI) engine 250, a vector database 260, a feature extraction module 214, a model database 262, and a model selector module 265. The sensor(s) 200 may be similar to the sensor(s) 120. The detection engine 210, the training engine 220, the model diagnostic engine 240, and the GUI engine 250 may be hardware modules and/or software modules executed on a computer (e.g., a remote server or a client device) having some or all of the components computer system, for example, of the computer system 600 described with respect to FIG. 5. The computing system 110 may include additional, fewer, or different components than depicted in FIG. 2. For example, the sensor(s) 200 may be excluded from the computing system 110 and instead, the computing system 110 may be communicatively coupled to third party sensors. The computing system 110 may be executed across two or more computer systems that are communicatively coupled with each other.

The detection engine 210 is configured to detect objects within data, such as image data (e.g., images and videos) and/or audio data. The detection engine 210 uses one or more object detection model(s) 211 (generally object detection model 211). The object detection model(s) 211 may be machine learning models. Example models used by the detection engine 210 include text classifiers, computer vision models, conversional neural networks, diagnostic models, transformers, autoencoders, or any suitable trained machine learning model. An object detection model(s) 211 may predict bounding boxes of one or more target objects depicted within an image input to the object detection model(s) 211. For example, given an image/, an object detection model 211 may predict bounding boxes according to Equation (1), where N is the number of detected objects. Equation (1) may be applied through YOLO V8. Although YOLO V8 is described with respect to calculations of equations described herein, any suitable object detection modeling algorithm may be used.

Boxes_{Detection}={(xₘᵢₙ,yₘᵢₙ,xₘₐₓ,yₘₐₓ)}ᵢ₌₁^{N} Equation (Eq.) (1)

For an input image tensor, T, the detection engine 210 can generate a CAM using Equation (2), where M, is the model, L are the target layers, and T is the transformed image tensor. While Equation (2) may be applied through YOLO V8, the detection engine 210 may generate a CAM by computing the first principle component of 2D activations in a neural network without taking class discrimination into account.

CAM(T)=EigenCAM(M,L,T) Equation (2)

If the CAM is multi-channel, the grayscale CAM can be delivered by averaging the channels. Let CAM (T) be a tensor with dimensions (C,H,W), where C is the number of channels and H and W are the height and width of the CAM. The grayscale CAM (GrayscaleCAM) can be obtained through Equation (3) via YOLO v8.

$$GrayscaleCAM ( x , y ) = \frac{1}{c} {\sum }_{c = 1}^{C} {CAM}_{c} ( T ) ( x , y ) \qquad Eqution ( 3 )$$

where CAM_{c}(T)(x, y) is the activation value at position (x, y) in the c-th channel of the CAM, C is the number of channels in the CAM, and GrayscaleCAM(x, y) is the resulting grayscale activation value at position (x, y).

The training engine 220 is configured to train or re-train an object detection model 211. The training engine 220 may train an object detection model 211 initially using a dataset of images of various classes corresponding to the target objects the images depict. The dataset of image of various classes may be a predefined (or predetermined) set. The dataset of images for training an object detection model 211 may be referred to as a labeled image dataset. The training engine 220 may train an object detection model 211 to detect one or more target objects within an image. Training engine 220 may train (or retain) object detection models to specialize in detecting objects over a variety of specific situations (e.g., a model is trained to detect an object in a specific environment, during a specific type of event or circumstance, in a specific lighting condition, during a specific time of day, in a specific weather condition, or any combination thereof). The training engine 220 may re-train an object detection model 211 based on feedback indicating a metric of accuracy of the object detection model 211. Example feedback may include an indication that the output of the model 211 is a false positive, a false negative, a bounding box around the target object depicted in an image or video, or any suitable indication of a degree to which the output of the object detection model is accurate. The feedback may be user feedback or feedback through other channels such as automated artificial intelligence feedback.

The training engine 220 may be configured to re-train an object detection model 211 using the vector database 260. After receiving feedback of an output of an object detection model 211, the training engine 220 may generate and store in the vector database 260 a data structure which can subsequently be used to re-train the object detection model 211. The data structure may include one or more inputs to the object detection model 211, an output of the object detection model 211, or feedback on the output. Alternatively, the data structure may include pointers to one or more of the one or more of an input to the object detection model 211, an output of the object detection model 211, or feedback on the output. For example, the training engine 220 generates the data structure including an embedding representative of an image input into the model 211, the image, a CAM, and a CAM score. The data structure may be indexed in the vector database 260 according to the embedding (i.e., the data structure may be queried from the vector database 260 using the embedding). The training engine 220 may store the generated data structure into the vector database 260. The data structure may also be used by the model diagnostic engine 240 to provide explanations of the detections determined by the object detection model(s) 211.

The training engine 220 also may be configured to receive training images provided from a source, e.g., images uploaded by a user, after the model diagnostic engine 240 has determined with which images to re-train an object detection model 211 and prompted the source to provide the images. For example, the model diagnostic engine 240 determines that images of a target object at different angles are needed to re-train an object detection model 211 and the training engine 220 receives the images to re-train the object detection model 211. This determination of which images to re-train a model is described further with respect to the model diagnostic engine 240.

The training engine 220 also may be configured to train a machine learning model based on one or more training algorithms. Examples of training algorithms may include mini-batch-based stochastic gradient descent (SGD), gradient boosted decision trees (GBDT), support vector machine (SVM), neural networks, logistic regression, naïve Bayes, memory-based learning, random forests, decision trees, bagged trees, boosted trees, or boosted stumps.

The training database 230 may be configured to store training datasets, image data transmitted by the sensor(s) 200, or user feedback received from the client device(s) 130.

The graphical user interface (GUI) engine 250 may generate a GUI through which a user can receive notifications of object detections made by the computing system 110 or can provide feedback on the accuracy of the object detections. The GUI engine 250 may update generated GUIs in response to user interactions.

The model diagnostic engine 240 may be configured to assess the accuracy of the object detection model(s) 211 and also may be configured to determine recommendations for improving the accuracy. The model diagnostic engine 240 uses the CAM output by an object detection model 211 to assess the model's accuracy. The model diagnostic engine 240 receives user feedback on the output of the object detection model 211 and generates a CAM score using user feedback, where the CAM score represents a metric of accuracy of a given object detection model. The model diagnostic engine 240 determines a model score of the given object detection model using the determined CAM score.

If the computing system 110 maintains multiple object detection models 211, the model diagnostic engine 240 uses the model score to compare the accuracy of one model to another. For example, if two of the object detection models 211 are trained to detect the same target object, the model diagnostic engine 240 may determine that one model is more accurately detecting the target object than the other and determine a higher model score for that model. The model diagnostic engine 240 may prompt the user, through the GUI engine 250, to provide particular training images to improve the accuracy of the object detection model whose model score is lower than the other or prompt the user, through the GUI engine 250, to use the object detection model with higher accuracy.

The model diagnostic engine 240 is configured to determine a CAM score based on a CAM and a bounding box around a target object depicted in an image. The model diagnostic engine 240 can determine, using the CAM, a set of pixels of the image satisfying a threshold contribution score, where the threshold contribution score indicates a level of contribution to the detection of the target object output by the object detection model. The model diagnostic engine 240 can determine internal pixels of the set of pixels and external pixels of the set of pixels. The internal pixels are pixels within the bounding box, which may include the pixels overlapping with the bounding box, and the external pixels are pixels located outside of the bounding box. The model diagnostic engine 240 can determine a CAM score based on a ratio of the internal pixels to the external pixels, a percentage of internal pixels to the total set of pixels, or any suitable metric of detection accuracy based on the bounding box. Additional methods for calculating CAM scores based on a combination of various scores (e.g., entropy, peak activation, and concentration scores) are also described herein.

The model diagnostic engine 240 may automatically determine the CAM score for an object detection model's output. An object detection model may be trained to output one or more predicted bounding boxes in an image, where each predicted bounding box captures a likely target object depicted in the image. The model diagnostic engine 240 may transform a CAM into grayscale for simplified visual representation in addition to reducing calculations needed to analyze the CAM relative to a colored CAM. The model diagnostic engine 240 may integrate multiple metrics to evaluate the quality and relevance of the CAMs for each predicted bounding box in the image.

The metrics may include a concentration score, peak activation score, and an entropy score. The concentration score may measure the density of activations within the predicted bounding boxes and providing sights into how well the model focuses on the objects of interest. The concentration score may be calculated using Equation (4), via YOLO V8, where N is the number of predicted bounding boxes and Boxᵢ is the i-th predicted bounding box.

$$Concentration = \frac{1}{N} {\sum }_{i = 1}^{N} \frac{{\sum }_{( x , y ) ϵ {Box}_{i}} GrayscaleCAM ( x , y )}{Area ( {Box}_{i} )} \qquad Eqution ( 4 )$$

The peak activation score may combine global and focused peak activations, assessing the intensity and distribution of these activations. The peak activation score may be calculated using Equation (5), via YOLO V8, where

$$Global\_Peak = σ ( GrayscaleCAM ) and Focused\_Peak = \frac{1}{N} {\sum }_{i = 1}^{N} σ ( {GrayscaleCAM}_{{BOX}_{i}} ) .$$

Peak_Activation=∝·Focused_Peak+(1−α)·Global_Peak Equation (5)

The entropy score may be calculated as a weighted average of global and focused entropy, capturing the uncertainty and spread of activations. The entropy score may be a weighted average of global and focused entropy as calculated by Equation (6), via YOLO V8, where

$$Global\_Entrpy = H ( GrayscaleCAM ) and Focused\_Entropy = \frac{1}{N} {\sum }_{i = 1}^{H} H ( {GrayscaleCAM}_{{Box}_{i}} ) .$$

Entropy=β·Focused_Entropy+(1−β)·Global_Entropy Equation (6)

By combining these scores with specific weights, the model diagnostic engine 240 may determine a CAM score that encapsulates the model's interpretability and reliability. This multifaceted evaluation enhances the transparency of the object detection model(s) 211 and provides a framework for comparing different models based on their ability to be explained, e.g., to a recipient, for example, a user. The CAM score maybe calculated by Equation (7), where ω_{c}, ωₚ, and ωₑ are the weights for concentration, peak activation, and entropy, respectively.

CAM_SCore=ω_{c}·Concentration+ωₚ·Peak_Activation−ωₑ·Entropy Equation (7)

The model diagnostic engine 240 may determine, after determining that a CAM score is lower than a threshold CAM score, one or more types of additional training images that would improve the accuracy of an object detection model whose outputs are producing the low CAM score. In one example, the model diagnostic engine 240 determines that a CAM score for an object detection model trained to detect motorcycles and bicycles has a higher CAM score for detecting motorcycles than for detecting bicycles. In response, the model diagnostic engine 240 causes, through the GUI engine 250, a prompt to be displayed at a client device requesting additional training images of bicycles. Additionally, the model diagnostic engine 240 can request that the additional training images be of bicycles at different angles, backgrounds, lighting, sizes, colors, any suitable variation in characteristic of depicting a bicycle (i.e., the target object), or a combination thereof.

In another example, the model diagnostic engine 240 determines that a CAM score for a first object detection model trained to detect motorcycles and bicycles is lower than a second object detection model also trained to detect motorcycles and bicycles. In response, the model diagnostic engine 240 causes, through the GUI engine 250, a prompt to be displayed at a client device recommending that the user switch to using the second object detection model instead of using the first object detection model.

The model diagnostic engine 240 determines a model score of the given object detection model using the determined CAM score. One example equation for calculating a model score is shown by Equations (8)-(12). The model diagnostic engine 240 can calculate individual average scores across multiple images. An average CAM score, average concentration score, average peak activation score, and average entropy score may be calculated by using Equations (8)-(11), respectively, where K is the number of images. The final model score is determined using Equation (12).

$${μ}_{CAM} = \frac{1}{K} {\sum }_{k = 1}^{K} {CAM\_Score}_{k} \qquad Equation ( 8 )$$

$${μ}_{Concentration} = \frac{1}{K} {\sum }_{k = 1}^{K} {Concentration}_{k} \qquad Equation ( 9 )$$

$${μ}_{Peak\_Activation} = \frac{1}{K} {\sum }_{k = 1}^{K} {Peak\_Activation}_{k} \qquad Equation ( 10 )$$

$${μ}_{Entropy} = \frac{1}{K} {\sum }_{k = 1}^{K} {Entropy}_{k} \qquad Equation ( 11 )$$

Model_Score=(μ_{CAM},μ_{concentration},μ_{Peak_Activation},μ_{Entropy}) Equation (12)

The GUI engine 250 is configured to generate notifications at a client device indicating the operations of the computing system 110. Examples of notifications can include model recommendations, object detections as output by the object detection model(s) 211, prompts requesting user feedback for the model diagnostic engine 240 to assess the accuracy of the object detection model(s) 211, prompts requesting additional training images (e.g., of different target objects or of the same target object at different angles), or recommendations, e.g., to the user, to use an object detection model that the system 110 has determined is more accurate.

The vector database 260 stores data for the model diagnostic engine 240 to assess the health of an object detection model 211, the training engine 220 to re-train a model, or a combination thereof. The vector database 260 may store previous object detection results of the computing system 110 and corresponding determinations of the accuracy of those results. As described with respect to the training engine 220, the vector database 260 can store data structures indexed to an embedding output by an object detection model when determining whether a target object was depicted in an input image. Each data structure can include the embedding, the input image, a CAM associated with the input image, and a CAM score determined based on user feedback of the detection result. The data structure can additionally or alternatively include pointers to one or more of the embedding, input image, CAM, and CAM score. The vector database 260 can include multiple databases (e.g., a different database for different object detection models).

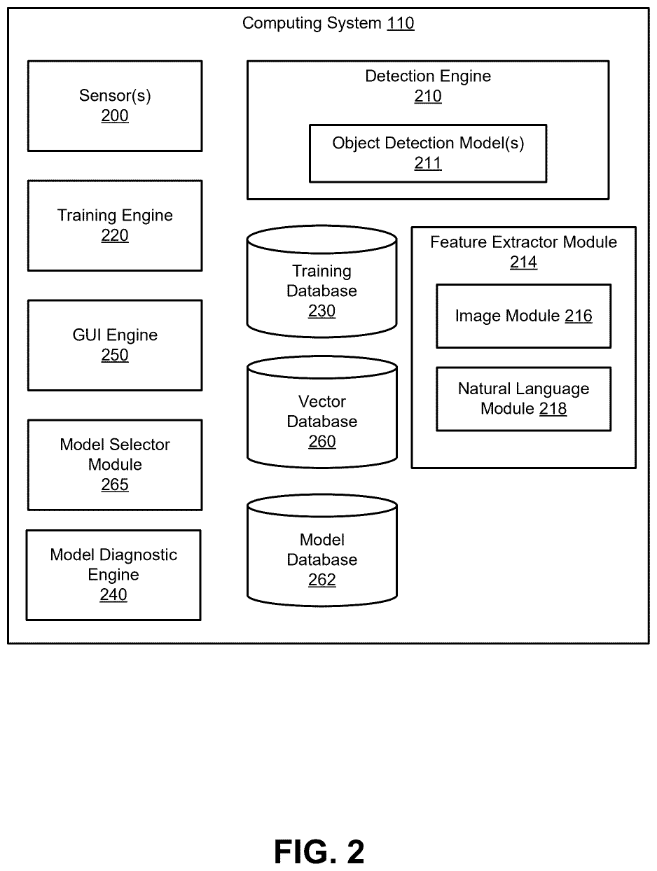

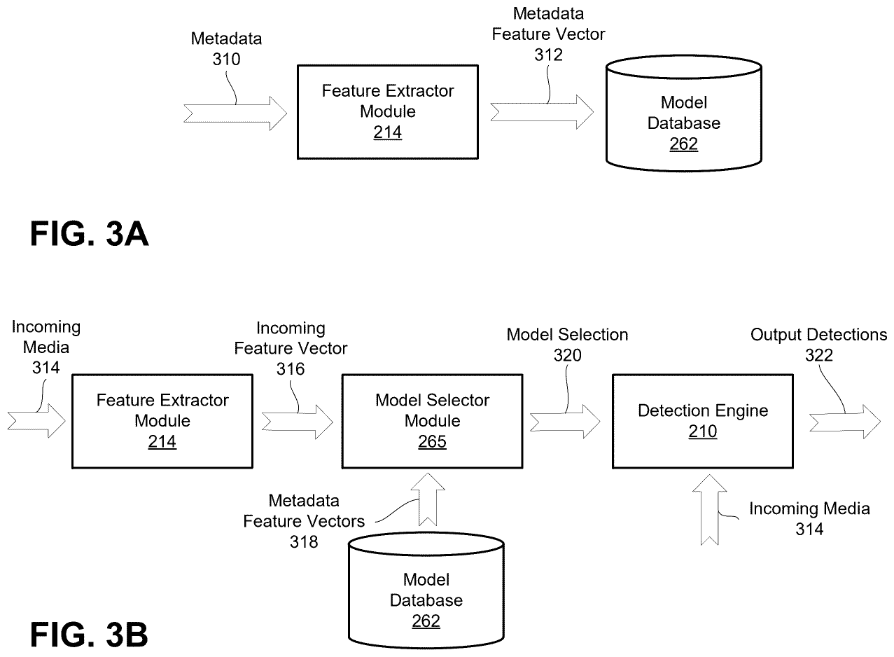

The feature extraction module 214, model database 262, model selector module 265, and detection engine 210 of FIG. 2 are described below in conjunction with FIGS. 3A-3B. FIG. 3A is a flowchart diagram illustrating how metadata feature vectors 312 (also referred to as embeddings) are generated, according to an embodiment. FIG. 3B is a flowchart diagram illustrating how object detection models are selected and how output detections 322 are generated (by the selected object detection models), according to an embodiment.

As previously described, media may refer to data, such as image data (e.g., one or more images), video data, audio data, text data, or any combination thereof. Incoming media 314 and metadata 310 are examples of media. For example, incoming media 314 includes data captured by a sensor 200 (e.g., security camera footage to be applied to a human detection model). As used herein, media ‘representing an object’ may refer to the media being data that represents the object. For example, an image of an object in an environment or a video of the object in an environment are both examples of pieces of media that represent the object in the environment.

Incoming media 314 is media to be applied to an object detection model 211. Incoming media 314 (e.g., a portion of it) may also be used to determine which set of object detection models 211 the incoming media 314 should be applied to. In some embodiments, a piece of incoming media is used to determine which set of models 211 to apply to another piece of incoming media. In a first example, the incoming media 314 includes (or is) an image that is characteristic of the other piece of incoming media (e.g., it includes an object to be detected in the other piece of incoming media and it includes a similar situation as the other piece of incoming media). In a second example, the incoming media includes (or is) text or audio data describing (e.g., via natural language) a desired type of detection model or describing characteristics of another sample of media to be applied to an object detection model 211). The description may be provided by a user (e.g., who typed the description using a client device), and/or may be generated by a model, where the model is trained to provide the description. For example, a trained model receives one or more images (of the other piece of incoming media) and outputs a text description of the images (e.g., via natural language). Among other advantages, the trained model may be used to quickly automate descriptions of incoming media 314 to improve selection of a model for that incoming media (using feature extraction module 214 and model selector module 265 as further described below).

Feature extraction module 214 receives data (e.g., incoming media 314 or metadata 310) and transforms the data into a feature vector (e.g., incoming feature vector 316 or metadata feature vector 312). A feature vector is a vector that represents the corresponding data in (e.g., high-dimensional) dimensional space (e.g., high-dimensional space may refer to dimensions higher than four, ten, twenty, fifty, eighty, or one hundred). Among other advantages, for incoming media (e.g., 314), a feature vector can capture or represent various aspects of the media, such as semantic, temporal, and/or spatial aspects of the media. Thus, the use of feature vectors enables capturing of semantic understandings of the incoming of media. Additionally, feature vectors can allow similarity comparison. For example, feature vectors that are “close” together in (e.g., high-) dimensional space represent input data that is semantically similar from a human point of view.

Feature extraction module 214 can include modules configured to transform different types of data (e.g., 314, 310) into feature vectors (e.g., a different module for each type of data and/or for each type of sensor 200). In the example of FIG. 2, feature extraction module 214 includes image module 216 and natural language module 218. Image module 216 converts images (e.g., from a camera or video sensor) into feature vectors. Image module 216 may include submodules configured to transform different types of images into feature vectors (e.g., images of different resolutions). Natural language module 218 converts text or audio data representing natural language into one or more feature vectors (e.g., using a nomic text embedder). In some embodiments, natural language module 218 receives image data, generates text or audio data describing the image data (e.g., using a vision language model (VLM)), and then converts the text or audio data into one or more feature vectors.

In the example of FIG. 2, feature extraction module 214 includes just two modules. However, feature extraction module 214 may include additional, fewer, or different modules with similar feature vector functionalities. For example, feature extraction module 214 includes (a) an infrared module configured to convert infrared image data from an infrared camera into feature vectors, (b) a depth module configured to convert depth image data from a depth camera into feature vectors, (c) an audio module configured to convert audio data from a microphone into feature vectors, or (d) any combination thereof.

Model database 262 stores object detection models 211 that can be used by detection engine 212 to detect objects. For a given object to be detected (e.g., a boat), model database 262 may store object detection models 211 trained to detect that object over a variety of different situations. For example, a first object detection model 211 is trained to detect boats in the open ocean during daytime, a second object detection model 211 is trained to detect boats in the open ocean during nighttime, a third object detection model 211 is trained to detect boats in harbors during daytime, and a fourth object detection model 211 is trained to detect boats in harbors during nighttime. Additionally, model database 262 may include multiple object detection models 211 trained to detect the same object for the same situation. For example, model database 262 includes different types of models (e.g., models that perform object detection using different methods, such as neural network models (e.g., bounding boxes and segmentation) and non-neural network models) and and/or models trained using different training methods. Among other advantages, selection of one or more of the specialized models in model database 262 for the corresponding situation, may be more accurate at detecting an object (e.g., boats) than a generalized model trained to detect that object in all situations. Examples of different situations (that object detection model 211 may be specially trained for) include different environments, events, circumstances, lighting conditions, time of day, and weather conditions.

Model database 262 may also store metadata for the object detection models 211. Metadata 310 for a model 211 may be details (e.g., a text description) of the specific object and situation (e.g., lighting and environment) the model 211 is trained to handle. Metadata for a model may additionally, or alternatively, include a sample of media related to that model, such as a sample of media previously used to train the model or a sample of media (e.g., an image) with the specific object and situation the model is trained to handle (e.g., for a model trained to detect a human wearing a backpack at sunset, the sample media may be an image of a human wearing a backpack at sunset). Model database 262 may store metadata for each of the stored models 211.

Metadata for a model may be in the form of one or more metadata feature vectors (e.g., 312) (for this reason model database 262 may also be referred to as a “feature store”). For example, see FIG. 3A which illustrates how metadata feature vectors 312 are generated and stored in model database 262. In a first example, a description of a model (which is an example of metadata 310) is generated into a metadata feature vector 312 (e.g., by natural language module 218). In another example, sample media for a model (another example of metadata 310) is generated into a metadata feature vector 312 (e.g., by image module 216). The sample media may be an (e.g., labeled) image used to train the model, a (e.g., natural language) description of the image, a (e.g., natural language) description of the model (e.g., the situation and object the model is configured to detect), or some combination thereof. In some embodiments metadata for a model 211 may include many feature vectors (e.g., generated from the description and one or more sample media). For example, model database 262 stores over one hundred metadata feature vectors 312 for a given model. The number of feature vectors for a model may be based on the number of images used to train the model. For example, for each image used to train the model, model database 262 stores two feature vectors: a first feature vector generated from the image (e.g., by image module 216) and a second feature vector generated from a description of the image (e.g., by natural language module 218). As further described later, model selector module 265 may select a model by mapping (e.g., correlating) a metadata feature vector of a model (e.g., 312) (or a cluster of metadata feature vectors of a model) with an incoming feature vector (e.g., 316) of an incoming media (e.g., 314). Thus, among other advantages, multiple feature vectors for a model 211 may increase the ability (e.g., accuracy) of model selector module 265 to map feature vectors together.

Model selector module 265 receives an incoming feature vector (e.g., 314) and may maps it to a metadata feature vector (e.g., 318) (or multiple metadata feature vectors, such as a cluster of vectors). For example, model selector 265 using a distance function to perform the mapping. For example, Mahalanobis distance allows determining the similarity between the incoming feature vector and one or more (e.g., the distribution of) metadata feature vectors (e.g., representing the data on which a given model was trained). So, in this example, the “closest” cluster represents the most relevant model. In another example, model selector module 265 determines correlations between the incoming feature vector and a set of metadata feature vectors (or clusters of vectors). The incoming feature vector may then be mapped to the metadata feature vector (or cluster) with the strongest correlation.

After the mapping, model selector module 265 selects a set of one or more object detection models 211 according to the mapping (e.g., the model 211 which corresponds to the mapped metadata feature vector). For example, model selector module 265 selects the object detection model 211 with the strongest or highest feature vector mapping (e.g., the strongest or highest correlation). In the example of FIG. 3B, the model selection 320 is sent to and used by detection engine 210 to perform object detection on the incoming media 314 that corresponds to the mapped incoming feature vector 316. Said differently, detection engine 210 receives model selection 320 and then applies the selected model 211 to incoming media 314 to generate output detections 322 (note that incoming media 314 received by feature extraction module 214 may be a portion of incoming media 314 and thus larger than the incoming media 314 received by detection engine 210). In other embodiments, model selection 320 may additionally, or alternatively, be used to generate a model recommendation, and the recommendation may be sent to a user (e.g., via a client device) for review. For example, if the recommendation is approved, model selection 320 is then sent to detection engine 210.

Model selector module 265 may select multiple models 211 to be used by detection engine 210. Among other advantages, using multiple models may allow for a smoothing effect over the results of the specific models. For example, model selector module 265 may select two models (e.g., if the two models are trained to detect the same object for the same or similar situations). In another example, model selector module 265 selects: (a) one or more models with a threshold level of mapping, (b) a threshold number of models with the strongest mapping, and/or (c) all models with a threshold level of mapping to the incoming feature vector. Among other advantages, selecting multiple models may increase the overall detection accuracy of the system and/or decrease switching time between models (e.g., if two models are similarly useful, selecting both models may reduce or eliminate the system spending resources to regularly switch between the models).

In embodiments where multiple models are selected to produce output detections 322, the detection accuracy of the models may be compared to determine whether one of the models performs significantly better than another. For example, previously determined measures of accuracy and/or measures of accuracy of current output detections 322 by the models may be compared (e.g., the CAM scores (or other metrics) from model diagnostic engine 240 are compared). If there is a threshold accuracy difference between two models, the lower accuracy model may not be used by detection engine 210. In some embodiments, the output detections of the selected two or more models is combined to form a single output detection 322 (this may be referred to as a “unified object detection”). The combination may be based on, for example, detection confidence, model selection confidence, or any combination thereof.

In one example use case of the computing system 110, the incoming media (e.g., 314) is a video feed of boats moving in and out of a harbor. The video feed is captured by a security camera positioned to monitor the harbor. As the video feed is processed, the feature extractor module 214 transforms portions of the video frames into one or more high-dimensional feature vectors that represent attributes of that portion (e.g., the temporal and spatial attributes). These feature vectors are then analyzed by the model selector module 265 (e.g., to determine the specific situation depicted in each portion of the video feed). For instance, certain portions of the video feed depict boats docked at the harbor, while other portions show boats navigating open water (e.g., the orientation or position of the security camera changes over time).

When a portion of the video feed shows boats docked at the harbor, the model selector module 265 may (based on the corresponding feature vector(s) for that video portion) select a specialized model trained to detect boats in a docked environment (e.g., considering other factors as well, such as time of day). Conversely, when a portion of the video feed transitions to boats navigating open water, the model selector module 265 may (based on the corresponding feature vector(s) for that portion of the video feed) switch to a specialized model optimized for detecting boats in open water (e.g., considering other factors as well such as lighting conditions).

This dynamic model selection helps ensure high-fidelity detections tailored to the specific situations within the different portions of the video feed, thereby improving overall detection accuracy and model selection efficiency. The system's ability to adapt to changing situations (e.g., in real-time) enhances its practical utility in applications such as security monitoring and traffic management in maritime environments.

### Additional Descriptions of Selecting and Using Object Detection Models

The paragraphs in this section provide additional descriptions of various embodiments. These descriptions may be part of, in addition to, or alternative to, previous descriptions.

Metadata 310 for a model may include one or more (e.g., labeled) images which are being used to train the model or were used to train the model. For example, if a user is creating a model by labeling images (e.g., from videos), one or more (e.g., each) of these labeled images may be mappable, 1-to-1, with a model generated or being generated from that labeled data. As previously described, feature extraction module 214 can transform these labeled images into metadata feature vectors 312. A metadata feature vector 312 generated from an image may be referred to as an “image feature vector.” Thus, in some embodiments, by including image feature vectors, one or more models may be selected based on the similarity between a piece of incoming media and the media used to train those one or more models.

In some embodiments, feature extraction module 214 uses the hiera model to generate image metadata feature vectors (the hiera model may be or be part of image module 216). Among other advantages, the hiera model can be efficient and can perform well at capturing image features independently from a specific object detection task, (e.g., when it is trained using masked autoencoders (MAE)).

As previously described, a feature vector (e.g., 312) may be generated from a (e.g., natural language) description of the model or of one or more (e.g., labeled) images which are being used to train the model or were used to train the model. This may be performed by natural language module 218. The description may be provided by a user or by a vision language model (VLM). Examples of VLMs include SmolVLM or Molmo 1B. An example prompt for a VLM is: “describe this image; make sure to describe the setting and background as well as the objects and actions.” In one example, a nomic text embedder is used to generate a metadata feature vector 312 from a description). A VLM and text embedder may be part of natural language module 218. A metadata feature vector 312 generated from a description may be referred to as a “description feature vector.”

Computing system 110 (e.g., via feature extraction module 214) may form clusters of feature vectors or clusters that represent feature vectors (e.g., image and/or description feature vectors). The clusters may be stored in model database 262. Each cluster is mapped to a corresponding model. This may result in a cluster space describing metadata (e.g., 310) for each model, where clusters are mapped to specific, trained models that the system 110 has access to. In one example, the clusters are variational Bayesian Gaussian Mixture (VBGM) clusters generated by one or more variational Bayesian Gaussian mixture models. In this example, a VBGM model may generate clusters by fitting a variable number of Gaussian distributions that describe or correspond to sets of metadata feature vectors. In other words, clusters are formed according to Gaussian distributions. In some embodiments, multiple gaussians may be used to model each cluster, which may allow for “oddly shaped” high-dimensional clusters. Although the above descriptions are in the context of Gaussian distributions, Gaussian distributions are not required.

Note that feature extraction module 214 may naturally form separate clusters for description feature vectors and image feature vectors. Thus, a model may be associated with multiple clusters depending on the generated metadata feature vectors. For example, a model is associated with a first cluster of description feature vectors and a second cluster of image feature vectors.

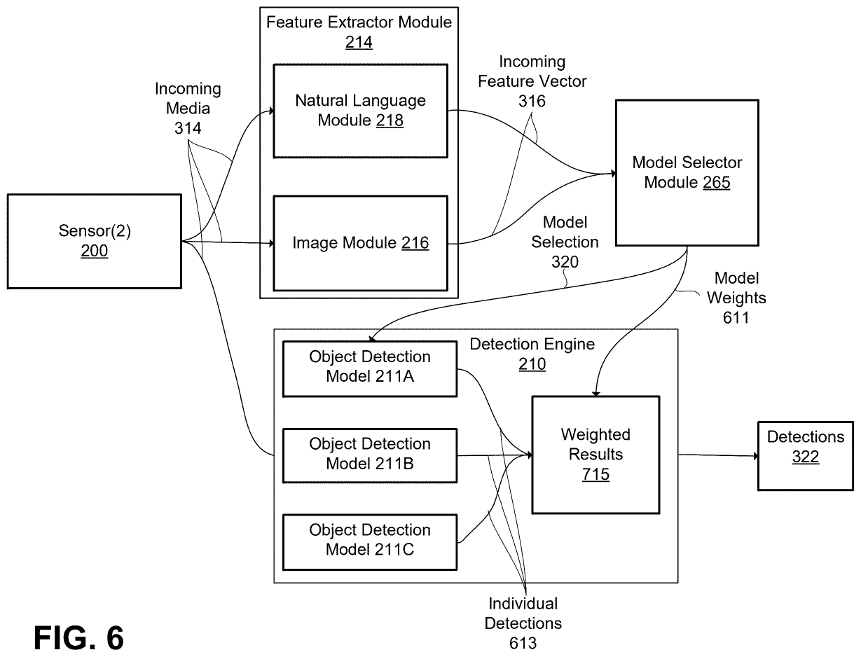

At inference time, as data (e.g., 314) comes into system 110 (e.g., from a sensor 200), feature vectors 316 are created (e.g., as often as is possible) as previously described. For real-time video, this is likely not every frame. FIG. 6 is a flowchart that illustrates an example inference flow, according to one or more embodiments. FIG. 6 is an example embodiment of the flowchart in FIG. 3B.

In the example of FIG. 6, as an incoming media 314 comes in from a sensor 200 (or another source, such as a database), images of the incoming media 314 are provided to natural language module 218, image module 216, and a set of N trained object detection models of detection engine 210 (in the example of FIG. 6, N=3). Note that incoming media 314 is not required to be sent to both natural language module 218 and natural language module 218. Natural language module 218 and image module 216 generate incoming feature vectors 316. If a piece of incoming media 314 is blocked at one of these stages (e.g., the stage is still running inference on a previous piece), the piece of incoming media may be dropped or stored until later (e.g., until inference on the previous piece is complete).

In FIG. 6, model selector module 265 receives an incoming feature vector 316 and determines a model selection 320 based on that incoming feature vector 316 and the model clusters. To determine a model selection 320, model selector module 265 may determine likelihoods (e.g., via a probability model) that an incoming feature vector 316 is part of model clusters. Model selector module 265 may then select the set of N models based on the probabilities. In the example of FIG. 6, the three models (labeled 211A, 211B, and 211C) associated with the three highest likelihoods are selected by model selector module 265. More generally, model selector module 265 may select the set of N models based on weights 611 for the models, where the model weights are based on the likelihood (in some embodiments, the weights are the likelihood or proportional to the likelihood).

In a first example selection, if a cluster represents a statistical distribution (e.g., a Gaussian distribution), then model selector module 265 may determine the statistical likelihood a given incoming feature vector 316 belongs to the distribution of that cluster. Model selector module 265 may perform this determination for all of the model clusters. Thus, for example, if an incoming image is widely different from images used to train a given model, then the corresponding feature vector for that incoming image would be far outside of the statistical distribution of the cluster associated with that model (where the cluster was formed from feature vectors of image data used to train that model).

In a second example selection, for a given incoming feature vector 316, model selector module 265 determines a distance from that vector to model clusters. For example, model selector module 265 determines the Euclidian distance to one or more feature vectors of each cluster (or the center of mass of each cluster) or the Mahalanobis distance to each of the clusters. The smaller a distance value (in other words, the closer the distance value is to zero) between a cluster and that incoming feature vector 316, the higher the liklihood the corresponding model will be a good fit for the data associated with that incoming feature vector 316 (e.g., the corresponding incoming media 314). Thus, the smaller the distance value, the larger the model weight may be. In the example of FIG. 6, the three models (labeled 211A, 211B, and 211C) may have the largest model weights 611 because they are associated with the three smallest distance values.

As previously mentioned, model selection 320 is based on model weights 611. For example, model selector module 265 selects: (a) one or more (e.g., all or a threshold number) models with at least a threshold weight and/or (b) a threshold number of models with the highest weights. In some embodiments, the weights 611 for the models are based on the analysis of a single incoming feature vector 316 by model selector module 265.

However, in other embodiments model weights 611 may be based on the analyses of multiple (e.g., many) incoming feature vectors 316. Among other advantages, this may reduce or prevent model “thrashing,” where models are constantly being swapped for each other during a situation transition period (e.g., transitioning from day to night). For example, the weight 611 of a model is a running average of the last X weights generated for that model, where the last X weights were generated based on the last X incoming feature vectors 316 (X is an integer number greater than one). Said differently, the weight 611 of a model is a running average of a threshold number of historical weights for that model. In another example, an autoregressive model determines weights 611 based on a number of historical weights. In some embodiments, a Kalman filter is used to determine weights 611, where historical weights are treated as observed measurements with noise (or other inaccuracies).

In all of the above examples, when a new weight is determined for a model (e.g., based on a new incoming feature vector 316), the previous weight 611 for that model may be updated to reflect the new weight (e.g., the running average is updated to include the new weight). The number of historical weights used to determine a weight 611 may be a fixed number, based on a user selection, aspects of the data (such as uncertainties in the data (e.g., reflected in qualities of the statistical distributions of the clusters)), or any combination thereof. As previously mentioned, a weight for a model is based on the likelihood a feature vector is part of a cluster associated with that model. Thus, historic weights for a model are based on likelihoods that previous feature vectors are part of the cluster associated with that model.

In some embodiments, a Bayesian model (e.g., part of model selector module 265) may be used to predict how likely it is that a situation transition has occurred. For example, as the sun sets, and it becomes more and more likely that a nighttime model should be used, there comes a point when the daytime and nighttime models provide an equal fit with the data (e.g., the model clusters have similar distances with the incoming feature vectors). The Bayesian model may work similarly to a Kalman filter, and may help prevent model “thrashing,” where the models are constantly being swapped for each other, from occurring during this transition period. The Bayesian model may produce likelihoods for each of the candidate models that will inform which models are currently running as part of the N current models. The likelihood weights produced by this model may also used to weigh the prediction results from the N running models. When a new model displaces a running model, the new model may be started and confirmed functional before the old model is stopped. During this time period, the previous (e.g., Bayesian model) weighting may be used to weigh results. When the new model is online, the new (e.g., Bayesian) weighting may be swapped in as well.

The Bayesian model may take into account the current situation and the likelihood of a situation transition itself alongside the likelihood of a given model being selected given the vector/cluster distances. In practice, while it is likely that a transition occurs from day to night, it is unlikely that there will be an quick change from night back to day. At a high-level, this takes in some set of hard-coded priors relating to the likelihood that a situation transition has occurred which would necessitate model transitions.

The N>1 selected models may run in parallel to produce individual object detection results 613. The individual detections may then be used to form a singular detection 322 (also “unified object detection”). A score for a unified detection may be formed using the weights (e.g., 611) to weigh the outputs coming from each individual model and combine them into an overall score, as further described below. The unified detection may be a detection (e.g., a bounding box or group of pixels) formed to include individual detection results that detect the same object (e.g., determined using intersection over union (IoU) as further described below). For example, the unified detection is a detection (e.g., bounding box in an image or group of pixels in the image) that includes one or more of the individual detections (e.g., each of the bounding boxes or groups of pixels from the individual detections).

Among other advantages, using multiple models may allow for a smoothing effect over the results of the specific models. The number of models N may be variable, e.g., depending on the weights 611 and/or the available resources of system 110. N may even be one (in this case, the system 110 still functions as intended). However, with only a single model running, the transition between models may create a more jarring experience between the detections being produced.

In some embodiments, an intersection over union (IoU) model may be used (relative to other detection results, not the ground truth), along with the weighting for each model, to determine when multiple models are predicting the same detection, coupled with a threshold to get rid of low-quality predictions. For example, given a model with a low weight predicting a detection with a high confidence score, it still may be the case that the weighted score does not meet the threshold without some other number of models agreeing, and lending their weight, to the detection. The following paragraphs further elaborate on these concepts.

Assume, for example, that three models 211 are being used in an ensemble: models A, B and C (i.e., N=3 in this example). The (e.g., Bayesian) weighting might be 0.6 for the output of model A, 0.3 for the output of model B, and 0.1 for the output of model C. This indicates the (e.g., Bayesian model's) preference for models A and B over model C, which has a low weighting (of 0.1). Assume that model C predicts an object (e.g., a boat) with a confidence score of 0.9. If model C were the only model running, a confidence score of 0.9 represents a high level of confidence by model C. However, because model C is running as part of an ensemble, the overall confidence score is actually 0.9*0.1=0.09, which is a low score. Thus, even though 0.9 is a high-confidence relative to model C, it's a low confidence relative to the model ensemble. In some embodiments, a detection 322 has at least a threshold confidence score. Otherwise, a detection may be disregarded. For example, using the previous example of model C's detection having an ensemble confidence score of 0.09, that detection may be dropped, unless, for example, model A or B to also spot the same object such that the ensemble confidence score increases to at least the threshold.

As previously described, IoU may be used to determine if more than one model detects the same object. For example, if individual detections (e.g., 613) from two different models have at least a threshold overlap (e.g., bounding boxes or identified pixels of each detection have a threshold overlap), then the two individual detections may be considered to be detecting the same object. If two or more models detect the same object (e.g., determined via IoU), then weights for those models may be used to determine an overall ensemble confidence score for the detection. Using the example from the previous paragraph, if model A and model B both detect an object (with the intersection over union being above the threshold) and model A's detection has a confidence score of 0.5 and model B's detection has a confidence score of 0.6, then the overall ensemble confidence score (also referred to as a “combined confidence score”) for the detection is the weighted average i.e., (0.5*0.6)+(0.6*0.3)=0.48. If 0.48 meets or exceeds the ensemble confidence score threshold, then that detection may be output as a detection 322 (as previously mentioned, this may be referred to as a unified object detection). Otherwise, that detection may be disregarded.

### Example for Selecting and Using Object Detection Model

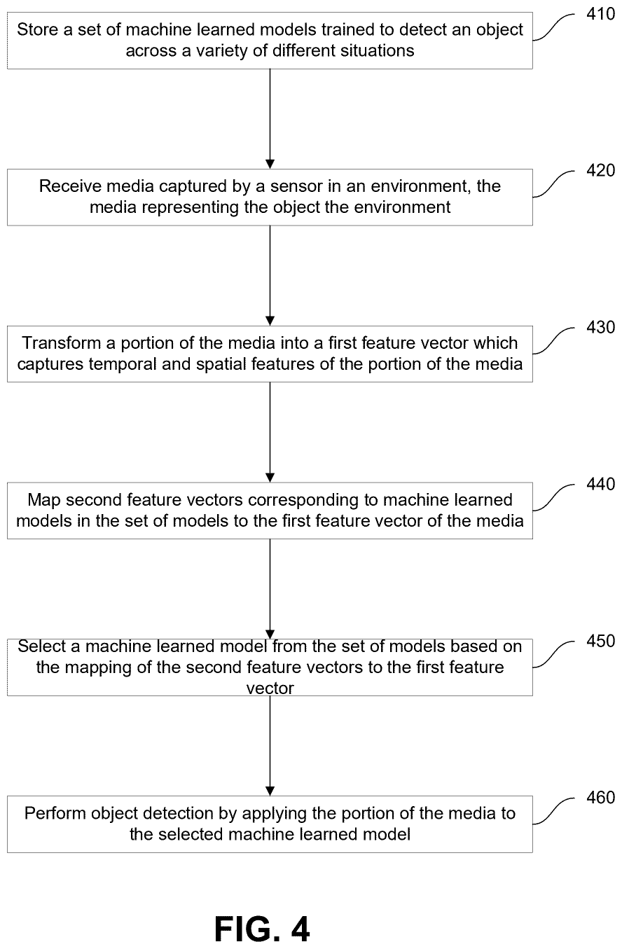

FIG. 4. is a flowchart for a method for determining an object detection model and performing object detection, in accordance with one or more embodiments. The example method of FIG. 4 is performed from the perspective of computing system 110, however this is not required. The method can include additional, fewer, or different steps than described. Additionally, the steps can be performed in different order, or by different components than described herein.

At step 410, computing system 110 stores a set of two or more machine learned models (e.g., models 211) trained to detect an object across a variety of different situations (e.g., via model database 262). For example, each model is trained to detect the object for a different situation (e.g., a specific environment, during a specific type of event or circumstance, in a specific lighting condition, during a specific time of day, in a specific weather condition, or any combination thereof).

At step 420, computing system 110 receives media (e.g., 314) captured by a sensor (e.g., 200) in an environment, the media representing the object the environment.

At step 430, computing system 110 (e.g., via 214) transforms a portion of the media into a first feature vector (e.g., 316) which captures temporal and spatial features of the portion of the media.

At step 440, computing system 110 (e.g., via 265) maps second feature vectors (e.g., 318) corresponding to machine learned models in the set of models to the first feature vector of the media.

At step 450, computing system 110 (e.g., via 265) selects a machine learned model (e.g., 320) from the set of models based on the mapping of the second feature vectors to the first feature vector.

At step 460, computing system 110 (e.g., via 210) performs (e.g., executes) object detection by applying the portion of the media to the selected machine learned model (e.g., a model 211).

In some aspects, the method further includes computing system 110 selecting a second machine learned model (e.g., another model 210) from the set of models based on the mapping of the second feature vectors to the first feature vector and performing a second object detection (e.g., via 210) by applying the portion of the media to the selected second machine learned model.

In some aspects, the method further includes computing system 110 transforming a second potion of the media into a third feature vector, mapping the second feature vectors corresponding to the machine learned models in the set of models to the third feature vector of the media; selecting a second machine learned model (e.g., another model 210) from the set of models based on the mapping of the second feature vectors to the third feature vector, and subsequent to applying the portion of the media to the selected model, applying the second portion of the media to the selected second model (e.g., via 210).

In some aspects, transforming the portion of the media into the first feature vector includes generating temporal and spatial features of the media.

In some aspects, transforming the portion of the media into the first feature vector includes at least one of: determining spatial correlations within the portion of the media; or determining temporal correlations within the portion of the media.

In some aspects, the method further includes computing system 110 receiving natural language data describing the media (the natural language data may be a second portion of the media that describes the first portion of the media), and transforming the natural language data into a third feature vector (e.g., via 218 of 214). In some aspects, mapping the second feature vectors includes mapping the second feature vectors to the first feature vector and the third feature vector, and selecting the machine learned model from the set of models is based on the mapping of the second feature vectors to (a) the first feature vector and (b) the third feature vector.

In some aspects, the method further includes computing system 110 receiving second media (e.g., 310) for a second machine learned model of the set of models, the second media including at least one of: a description of the second machine learned model, or an image used to train the second machine learned model. In some aspects, the method further includes computing system 110 generating (e.g., via 214) a feature vector of the second feature vectors by transforming the second media (e.g., 310) into the feature vector (e.g., 312) of the second feature vectors.

In some aspects, the media includes a plurality of images and the first feature vector captures temporal and spatial features of the plurality of images.

Other aspects include components, devices, systems, improvements, methods, processes, applications, computer readable mediums, and other technologies related to any of the above.

### Example for Performing Ensemble Object Detection

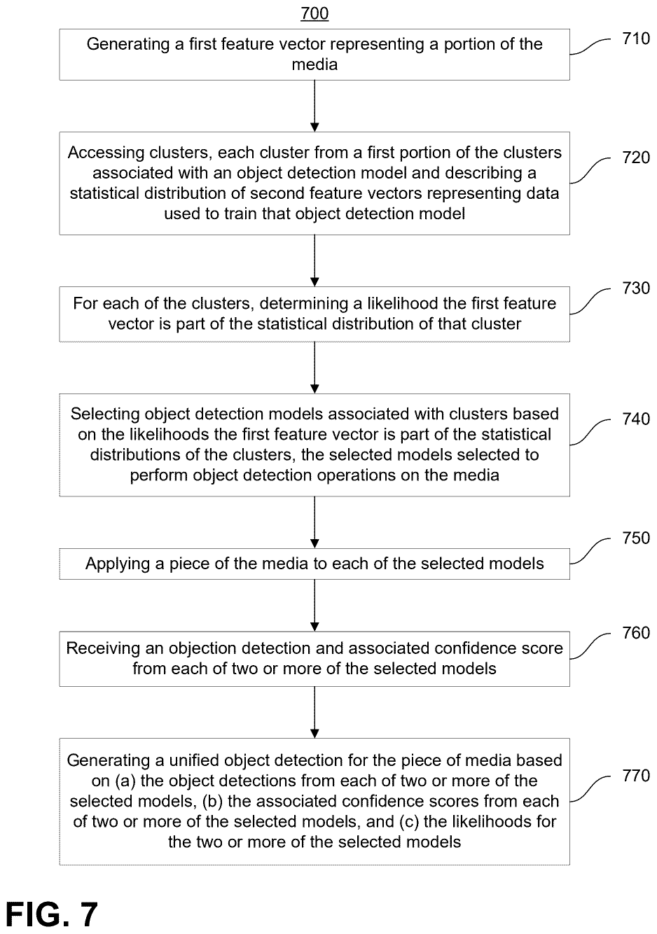

FIG. 7. is a flowchart for a method 700 for performing ensemble object detection on media, in accordance with one or more embodiments. The example method of FIG. 7 is performed from the perspective of computing system 110, however this is not required. The method can include additional, fewer, or different steps than described. Additionally, the steps can be performed in different order, or by different components than described herein.

At step 710, computing system 110 generates a first feature vector representing a portion of the media.

At step 720, computing system 110 accesses clusters, each cluster from a first portion of the clusters associated with an object detection model and describing a statistical distribution of second feature vectors representing data used to train that object detection model. A cluster may be associated with only a single model. However, a model may be associated with multiple clusters.

At step 730, computing system 110, for each of the clusters, determines a likelihood the first feature vector is part of the statistical distribution of that cluster.

At step 740, computing system 110 selects object detection models associated with clusters based on the likelihoods the first feature vector is part of the statistical distributions of the clusters, the selected models selected to perform object detection operations on the media.

At step 750, computing system 110 applies a piece of the media to each of the selected models.

At step 760, computing system 110 receives an objection detection and associated confidence score from each of two or more of the selected models.

At step 770, computing system 110 generates a unified object detection for the piece of media based on (a) the object detections from each of two or more of the selected models, (b) the associated confidence scores from each of two or more of the selected models, and (c) the likelihoods for the two or more of the selected models.

In some aspects, selecting the object detection models associated with clusters based on the likelihoods includes: updating weights of the object detection models, the updated weights based the likelihoods the first feature vector is part of the statistical distributions of the clusters associated with the object detection models and historic likelihoods other feature vectors are part of statistical distributions of clusters associated with the object detection models, the other feature vectors representing other portions of the media; and selecting the object detection models based on the updated weights of the object detection models.

In some aspects, generating the unified object detection for the piece of media includes: determining the object detections from the two or more of the selected models refer to the same object in the piece of media; determining a combined confidence score for the object detections, wherein the combined confidence score is a weighted average of the confidence scores, and the weights for the confidence scores are based on one of the likelihoods for the two or more of the selected models; and responsive to the combined confidence score meeting or exceeding a detection threshold, generating the unified object detection of the piece of media.

In some aspects, determining the object detections from the two or more of the selected models refer to the same object in the piece of media includes: performing an intersection over union (IoU) analysis; and responsive to determining at least a threshold overlap for each of the object detections from the two or more of the selected models, determining the object detections from the two or more of the selected models refer to the same object in the piece of media.

In some aspects, each cluster of a second portion of the clusters is associated with an object detection model and describes a statistical distribution of third feature vectors representing at least one of: text data describing that detection model, or text date describing an image used to train that object detection model.

In some aspects, t the first feature vector represents at least one of: an image of the media; or text data describing an image of the media.

In some aspects, the object detection models include object detection models trained to detect objects across a variety of different situations.

Other aspects include components, devices, systems, improvements, methods, processes, applications, computer readable mediums, and other technologies related to any of the above.

### Computing Machine Architecture

FIG. 5 is a block diagram illustrating components of an example machine able to read instructions from a machine-readable medium and execute them in a processor (or controller). Specifically, FIG. 5 shows a diagrammatic representation of a machine in the example form of a computer system 600 within which program code (e.g., software) for causing the machine to perform any one or more of the methodologies discussed herein may be executed. The program code may be comprised of instructions 624 executable by one or more processors 602. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system (or computing system) 600 includes a processing system. The processing system may be one or more processors 602 (e.g., one or more central processing units (CPUs), one or more graphics processing units (GPUs), one or more neural network processors (NNPs), one or more state machines, one or more digital signal processors (DSPs), one or more application specific integrated circuits (ASICs), one or more radio-frequency integrated circuits (RFICs), or any combination of these). The computing system 600 also may include a main memory 604, and a static memory 606, which are configured to communicate with each other via a bus 608. If the set of processors 602 includes multiple processors, the processors may operate individually or collectively to accomplish one or more operations. The computer system 600 may further include visual display interface 610. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 610 may include or may interface with a touch enabled screen. The computer system 600 may also include alphanumeric input device 612 (e.g., a keyboard or touch screen keyboard), a cursor control device 614 (e.g., a mouse, a trackball, a joystick, a motion sensor, or other pointing instrument), a storage unit 616, a signal generation device 618 (e.g., a speaker), and a network interface device 620, which also are configured to communicate via the bus 608.

The storage unit 616 includes a (e.g., non-transitory) machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The present disclosure provides significant technical improvements over existing generalized object detection models by employing a dynamic model selection system that utilizes specialized machine learning models tailored to specific situations. This approach addresses the limitations of generalized models, which often fail to provide accurate detections in specialized tasks. By transforming incoming media into high-dimensional feature vectors that represent the media's semantic attributes, the system can precisely map the media to suitable specialized models, ensuring high-fidelity detections tailored to the specific situation of the media. This dynamic model selection and switching based on real-time analysis of the media further enhance detection accuracy and efficiency.

The disclosure solves, for example, a technical problem of suboptimal detection performance in specific situations by providing a system that includes a library of specialized models trained to detect objects in various environments and conditions. The feature extractor transforms incoming media into feature vectors, allowing for precise mapping to suitable specialized models. This enables a system to differentiate between scenarios such as boats in a dock versus boats in open water or automobiles in a crowded intersection versus a low-traffic intersection, thereby improving overall detection accuracy and model selection efficiency.

The disclosed configuration improves, for example, detection accuracy in real-world scenarios. For example, the system can dynamically switch models based on changes in the situation represented by the media, such as varying lighting conditions. This capability enables an appropriate model is used for the given situation, resulting in more accurate and reliable detections. The disclosed configuration may be applicable to security monitoring, traffic management, and other fields where accurate object detection is useful, helpful, or important.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and/or their associated modules may be embodied in software, firmware, hardware, or any combinations thereof.

Throughout this specification, some embodiments have used the expression “coupled” along with its derivatives. The term “coupled” is not necessarily limited to two or more elements being in direct physical or electrical contact. Rather, the term “coupled” may also encompass two or more elements that are not in direct contact with each other, but yet still co-operate or interact with each other.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where values are described as “approximate” or “substantially” (or their derivatives), such values should be construed as accurate+/−10% unless another meaning is apparent from the context. From example, “approximately ten” should be understood to mean “in a range from nine to eleven.”

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus.

Furthermore, any computing systems referred to in the specification may include a single processor or may be architectures employing multiple processor designs for increased computing capability. Any computing systems including multiple processors may operate the multiple processors individually or collectively.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the disclosed subject matter. It is therefore intended that the scope be limited not by this detailed description, but rather by any claims that issue on an application based hereon. Accordingly, the disclosure of the embodiments are intended to be illustrative, but not limiting, of the scope, which is set forth in the following claims.

What is claimed is:

1. A non-transitory computer-readable storage medium comprising stored instructions that, when executed by a computing system, cause the computing system to:
store a set of machine learned models trained to detect an object across a variety of different situations;
receive media captured by a sensor in an environment, the media representing the object the environment;
transform a portion of the media into a first feature vector which captures temporal and spatial features of the portion of the media;
map second feature vectors corresponding to machine learned models in the set of models to the first feature vector of the media;
select a machine learned model from the set of models based on the mapping of the second feature vectors to the first feature vector; and
perform object detection by applying the portion of the media to the selected machine learned model.

2. The non-transitory computer-readable storage medium of claim 1, further comprising instructions that when executed cause the computing system to:
select a second machine learned model from the set of models based on the map of the second feature vectors to the first feature vector; and
perform a second object detection by applying the portion of the media to the selected second machine learned model.

3. The non-transitory computer-readable storage medium of claim 1, further comprising instructions that when executed causes the computing system to:
transform a second potion of the media into a third feature vector;
map the second feature vectors corresponding to the machine learned models in the set of models to the third feature vector of the media;
select a second machine learned model from the set of models based on the mapping of the second feature vectors to the third feature vector; and
apply the second portion of the media to the selected second model subsequent to application of the portion of the media to the selected model.

4. The non-transitory computer-readable storage medium of claim 1, wherein the instruction to transform the portion of the media into the first feature vector comprises instructions that when executed causes the computing system to generate temporal and spatial features of the media.

5. The non-transitory computer-readable storage medium of claim 1, wherein the instructions to transform the portion of the media into the first feature vector comprises instructions that when executed causes the computing system to at least one of:
determine spatial correlations within the portion of the media; or
determine temporal correlations within the portion of the media.

6. The non-transitory computer-readable storage medium of claim 1, further comprising instructions that when executed causes the computing system to:
receive natural language data describing the media; and
transform the natural language data into a third feature vector.

7. The non-transitory computer-readable storage medium of claim 6, wherein:
the instructions to map the second feature vectors comprises instructions that cause the computing system to map the second feature vectors to the first feature vector and the third feature vector; and
the instructions to select the machine learned model from the set of models further comprises instructions that cause the computing system to select the machine learned model based on a mapping of the second feature vectors to: (a) the first feature vector and (b) the third feature vector.

8. The non-transitory computer-readable storage medium of claim 1, further comprising instructions that cause the processing system to:
receive second media for a second machine learned model of the set of models, the second media including at least one of:
a description of the second machine learned model; or
an image used to train the second machine learned model.

9. The non-transitory computer-readable storage medium of claim 8, further comprising instructions to generate a feature vector of the second feature vectors through transformation of the second media into the feature vector of the second feature vectors.

10. The non-transitory computer-readable storage medium of claim 1, wherein the media includes a plurality of images and the first feature vector captures temporal and spatial features of the plurality of images.

11. A method for determining an object detection model and performing object detection, the method comprising:
storing a set of machine learned models trained to detect an object across a variety of different situations;
receiving media captured by a sensor in an environment, the media representing the object the environment;
transforming a portion of the media into a first feature vector which captures temporal and spatial features of the portion of the media;
mapping second feature vectors corresponding to machine learned models in the set of models to the first feature vector of the media;
selecting a machine learned model from the set of models based on the mapping of the second feature vectors to the first feature vector; and
performing object detection by applying the portion of the media to the selected machine learned model.

12. The method of claim 11, further comprising:
selecting a second machine learned model from the set of models based on the mapping of the second feature vectors to the first feature vector; and
performing a second object detection by applying the portion of the media to the selected second machine learned model.

13. The method of claim 11, further comprising:
transforming a second potion of the media into a third feature vector;
mapping the second feature vectors corresponding to the machine learned models in the set of models to the third feature vector of the media;
selecting a second machine learned model from the set of models based on the mapping of the second feature vectors to the third feature vector; and
subsequent to applying the portion of the media to the selected model, applying the second portion of the media to the selected second model.

14. The method of claim 11, wherein transforming the portion of the media into the first feature vector comprises generating temporal and spatial features of the media.

15. The method of claim 11, wherein transforming the portion of the media into the first feature vector comprises at least one of:
determining spatial correlations within the portion of the media; or
determining temporal correlations within the portion of the media.

16. The method of claim 11, further comprising:
receiving natural language data describing the media; and
transforming the natural language data into a third feature vector.

17. The method of claim 16, wherein:
mapping the second feature vectors comprises mapping the second feature vectors to the first feature vector and the third feature vector; and
selecting the machine learned model from the set of models is based on the mapping of the second feature vectors to (a) the first feature vector and (b) the third feature vector.

18. The method of claim 11, further comprising:
receiving second media for a second machine learned model of the set of models, the second media including at least one of:
a description of the second machine learned model; or
an image used to train the second machine learned model.

19. The method of claim 18, further comprising generating a feature vector of the second feature vectors by transforming the second media into the feature vector of the second feature vectors.

20. A system comprising:
a set of one or more processors; and
a computer-readable storage medium storing instructions that, when executed by the set of one or more processors, cause the set of one or more processors to perform operations comprising:
storing a set of machine learned models trained to detect an object across a variety of different situations;
receiving media captured by a sensor in an environment, the media representing the object the environment;
transforming a portion of the media into a first feature vector which captures temporal and spatial features of the portion of the media;
mapping second feature vectors corresponding to machine learned models in the set of models to the first feature vector of the media;
selecting a machine learned model from the set of models based on the mapping of the second feature vectors to the first feature vector; and
performing object detection by applying the portion of the media to the selected machine learned model.
